(19) United States
(12) Patent Application Publication
(10) Pub. No.: US 2012/0260326 A1
(43) Pub. Date: Oct. 11, 2012

(54) IMAGE MAPS FOR CREDENTIAL-BASED SECURITY

(75) Inventor: Uwe Steigmann, Daisbach (DE)

(73) Assignee: SAP AG, Walldorf (DE)

(21) Appl. No.: 13/080,332

(22) Filed: Apr. 5, 2011

(51) Int. Cl. H04L 9/32; G06F 21/00

(52) U.S. Cl. 726/7

(57) ABSTRACT

An input handler may receive a request, from a user of a client computer, for credential-based access to a server-based resource. An image map generator may determine a mapping between elements of an image map and secure transmission codes. A code generator may provide, to a user interface of the client computer, the mapping together with rendering code for rendering the image map. A mapping module may receive a sequence of the transmission codes from the user interface after a rendering of the image map by the user interface using the rendering code, based on a selection of image map elements by the user. The selected image map elements may represent the user credentials, and the sequence may correspond by way of the mapping to the selected image map elements and thus to the credentials.

### TECHNICAL FIELD

This description relates to credential-based security in computer networks.

### BACKGROUND

It is often very important and/or desirable to provide secure access to computer resources, e.g., in the context of a computer network. For example, such computer resources may include hardware and/or software resources which are provided for the benefit of a user of the computer system. Such a user may need or wish to access a given computer resource in a manner which is secured to a specified degree and/or in a specified manner. For example, the user may require confidential access to data which is associated with the user and managed by the computer resource in question. Similarly, the user may wish to ensure that no unauthorized users will have the ability to alter or delete any such data.

Accordingly, conventional systems exists which attempt to provide such secured access, at least in part, by requiring a user who is requesting access to a designated computer resource to enter credentials which are designed to be uniquely and securely associated with the requesting user. In examples of such systems, the requested credentials may include, e.g., a unique username and associated password, a personal identification number (PIN), a question/answer pair, or virtually any other information which is designed to be uniquely associated with the user, and which is often also designed to be difficult for other, (e.g., unauthorized) users to guess, derive, or otherwise determine.

In practice, a number of known techniques exist which are often used by unauthorized users who wish to gain unauthorized access to one or more computer resources which are secured using the types of user-based credential-based security schemes just referenced. For example, keyboard logging software exists which is designed to detect and track entry of individual keyboard keys during input of a password by a user. In this way, an unauthorized user may obtain the password of the user, and may thereafter use the illicitly obtained password to access confidential, personal, or otherwise secured data (or other computer resources) associated with the authorized user. Somewhat similarly, in a network context in which the user's credentials are transmitted over the network, e.g., for accessing a computer resource located on a remote network computer, network sniffers and other interception techniques may be implemented to intercept the transmitted password or other credential. As a result, again, unauthorized users who execute such interceptions of credentials may be enabled to obtain unauthorized access to otherwise-secured resources associated with the user.

As a result, providers of computer resources may find it difficult to ensure users of the providers' ability to provide security for such resources. Consequently, users may not have full trust in the security provided, and therefore may be unable or unwilling to utilize or obtain the full benefits of the provided resources. Moreover, to the extent that such trust is established inappropriately in the sense that unauthorized users may be able to compromise the provided security, e.g., in the manners just described, users may suffer from actual loss or compromise of confidential, personal, financial, or other information which the user wishes to manage and maintain securely. Thus, conventional credential-based security systems fail to provide an adequate or desired degree of security, to the detriment of providers, users, and potential users of such systems.

### SUMMARY

According to one general aspect, a system may include instructions recorded on a computer-readable medium and executable by at least one processor. The system may include an input handler configured to cause the at least one processor to receive a request, from a user of a client computer, for credential-based access to a server-based resource. The system may include an image map generator configured to cause the at least one processor to determine a mapping between elements of an image map and secure transmission codes. The system may include a code generator configured to cause the at least one processor to provide, to a user interface of the client computer, the mapping together with rendering code for rendering the image map. The system may include a mapping module configured to cause the at least one processor to receive a sequence of the transmission codes from the user interface after a rendering of the image map by the user interface using the rendering code, based on a selection of image map elements by the user, wherein the selected image map elements represent the user credentials, and wherein the sequence corresponds by way of the mapping to the selected image map elements and thus to the credentials.

According to another general aspect, a computer program product may be tangibly embodied on a computer-readable storage medium and may include instructions. When executed by a data processing apparatus, the instructions may be configured to cause the data processing apparatus to receive a request, from a user of a client computer, for credential-based access to a server-based resource, determine a mapping between elements of an image map and secure transmission codes, provide, to a user interface of the client computer, the mapping together with rendering code for rendering the image map, and receive a sequence of the transmission codes from the user interface after a rendering of the image map by the user interface using the rendering code, based on a selection of image map elements by the user wherein the selected image map elements represent the user credentials, and wherein the sequence corresponds by way of the mapping to the selected image map elements and thus to the credentials.

According to another general aspect, a computer-implemented method may include receiving a request, from a user of a client computer, for credential-based access to a server-based resource, determining a mapping between elements of an image map and secure transmission codes, and providing, to a user interface of the client computer, the mapping together with rendering code for rendering the image map. The computer implemented method may further include receiving a sequence of the transmission codes from the user interface after a rendering of the image map by the user interface using the rendering code, based on a selection of image map elements by the user, wherein the selected image map elements represent the user credentials, and wherein the sequence corresponds by way of the mapping to the selected image map elements and thus to the credentials.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for providing credential-based security.

FIG. 2 is a flowchart illustrating example operations of the system of FIG. 1.

FIG. 3 is a block diagram illustrating an information flow that occurs during operations of the system of FIG. 1.

FIG. 4 is a flowchart illustrating more detailed example operations of the system of FIG. 1.

### DETAILED DESCRIPTION

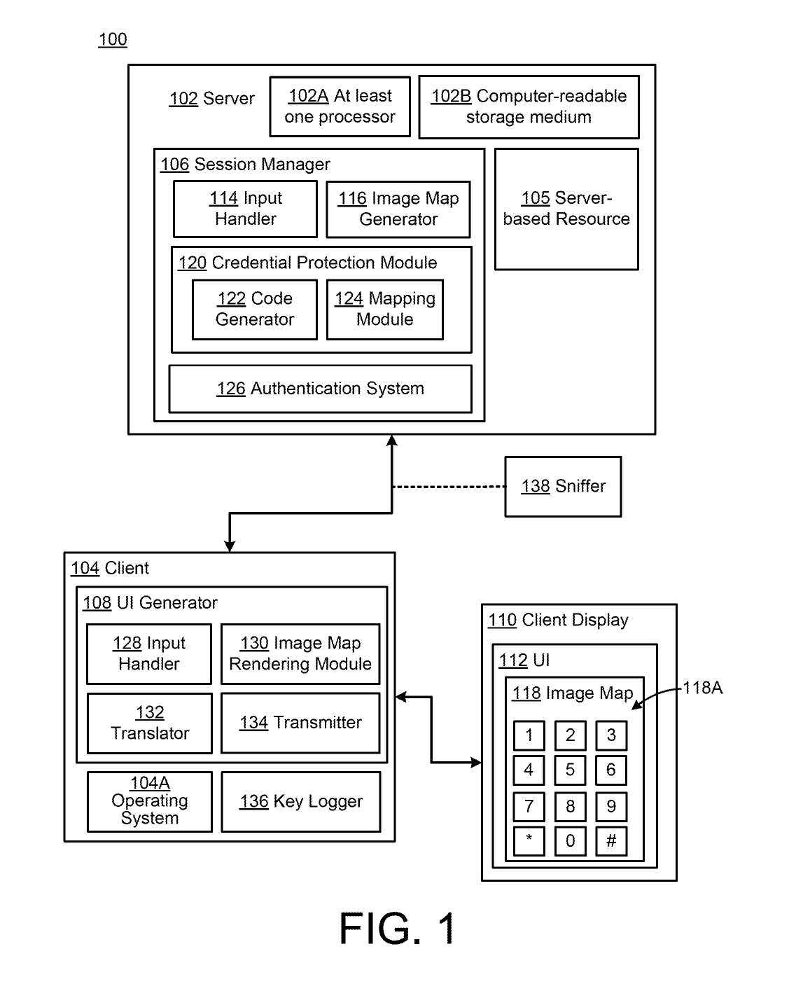

FIG. 1 is a block diagram of a system 100 for providing credential-based security. In the example of FIG. 1, a server 102 is illustrated as communicating with a client 104 in order to provide credential-based secure access to a server-based resource 105. As described in detail below, the system 100 enables the use of credential-based security techniques in a manner which is not susceptible, or not as susceptible, to known or future techniques for gaining unauthorized access using illicit obtaining of the credentials in question. Consequently, the system 100 of FIG. 1 may be instrumental in establishing trust between a provider of the server-based resource 105 and the user thereof, so that full benefits of the server-based resource 105 may be utilized and enjoyed in a secure fashion.

In the example of FIG. 1, it will be appreciated that the server 102 may represent virtually any computer configured to communicate with the client 104 to provide data, functionality, or virtually any service or benefit which may be offered in the context of a computer network. Conversely, then, the client 104 may then be understood to represent virtually any computer hardware and/or software which is configured to communicate with the server 102 to receive the benefit and use of such data, functionality, or other resources. Thus, the server-based resource 105 may be understood to represent virtually any computer hardware and/or software functionality or feature which may be provided to the client 104 over an intervening computer network (not specifically illustrated as such in the example of FIG. 1), e.g., for the use and benefit of a user of the client 104.

To provide a few examples, some of which are discussed in more detail below, it may occur that the server 102 represents an application server, a web server, or virtually any server which may be in communication with the client 104 over a private or public computer network, e.g., the public internet and/or a private (corporate) intranet. For example, the server 102 may represent a server of a bank, retailer, educational institution, government institution, corporation, or virtually any other entity which wishes to provide a website to designated groups or individuals, e.g., to employees, consumers, students, account holders, or computer public at large.

To give a specific, non-limiting example, the server 102 may be associated with a bank which wishes to provide account access to individual account holders using a publicly available website of the bank. In such an example, as is well known, it would be typical for the bank to associate the account (e.g., checking account or savings account) of the user with a unique username and password of the user. Then, the user may visit the website of the bank, and may request secured access to one or more of the user's bank accounts by implementing the credential-based access schemes described herein. As may be appreciated, the server-based resource 105 in this example may represent or include, e.g., account management functionality, funds transfer, bill payments, or virtually any banking services which may be provided via computer network.

As referenced above, large numbers of existing websites provided by conventional web servers utilize various forms of credential-based access. Consequently, large numbers of examples exist of possible use scenarios for the server 102, and, consequently, corresponding examples of the server-based resource 105. For example, a retailer may provide credential-based access to an individual user's account, so that the user's account may be used to store credit card information, delivery preferences, past order histories, or virtually any other user-specific information which may enhance the user's enjoyment of the retailer's website in question.

In still other examples, the server-based resource 105 may represent a specific service in its own right, as compared to the examples above in which the server-based resource 105 enhances existing usages of a particular website. For example, websites exist which provide remote data storage and/or remote processing resources which users may wish to access, and pay for, in a user-specific manner. Again, many other examples of the server 102 and the server-based resource 105 would be known to one of skill in the art, and therefore are not described herein in detail, except as may be necessary or helpful in understanding example operations of the system 100 of FIG. 1.

In providing credential-based access to the server-based resource 105, the server 102 may include a session manager 106 which may be configured to receive requests from users for secure access to the server-based resource 105, and to thereafter instantiate or otherwise create a temporary user session during which the requested access (if permitted) may proceed. For example, in the examples above, a user may visit a bank's website, and may request a login page for logging into designated bank accounts of the user. Consequently, the session manager 106 may generate a session during which the requested access (if permitted) to the bank accounts may precede. As described in detail below, credential-based access to the server-based resource 105 may thus be executed in the context of the specific session generated by the session manager 106.

It may be appreciated that many conventional systems utilize such sessions, by themselves, to provide conventional credential-based access to server-based resources. Consequently, many such features and aspects related to a creation, use, and termination of such user sessions are not described here in detail, except as may be necessary or helpful in understanding the operations of the system 100 of FIG. 1, but would be apparent to one of skill in the art nonetheless. For example, it may be appreciated that although sessions created by the session manager 106 may be temporary, related data may be created, updated, or deleted in a persistent manner which enables the use of such data within and among multiple instances of sessions created for a user by the session manager 106. Consequently, as is well known, the session manager 106 may thus require time limits or other criteria for terminating a specific session, and thereafter require re-entry of necessary credentials, in order to proceed with a subsequent secure session.

The session manager 106, and perhaps other components of the server 102 (including e.g., the server-based resource 105 itself) may communicate with a user interface (UI) generator 108 executing on the client 104. Continuing the examples above in which the server 102 provides a website being accessed by a user of the client 104, it may thus be appreciated that the UI generator 108 may represent or include an otherwise conventional network browser, such as, e.g., any one of the current or future commercial browsers which are, or may be, available. Such browsers may include, for example, Internet Explorer, the Chrome browser, the Mozilla Firefox browser, the Safari browser, or virtually any other browser technology which enables the client 104 to communicate with the session manager 106 and/or the server-based resource 105.

Nonetheless, it also may be appreciated that, in other context, the UI generator 108 may represent other types of client-specific software which enable the viewing of, and interaction with, data and functionality of the server-based resource 105. For example, the UI generator 108 may be associated in the context of a private corporate intranet with a custom user interface designed specifically for the users of the corporate intranet. Other examples of such UI technology, and features thereof, are described in detail below, or would be apparent to one of skill in the art.

In operation, the UI generator 108 may communicate with a client display 110 associated with the client 104, in order to generate a user interface (UI) 112. For example, in common examples where the client 104 includes a personal computer or desktop workstation, the client display 110 may include a monitor or other display which is connected thereto. Of course, in other examples, other conventional arrangements may be included. For example, the client 104 may represent a laptop, netbook, or notebook computer, in which the client display 110 may include an attached screen. In other examples, the client 104 may include a Smartphone, tablet computer, or other device which utilizes a touch screen as the client display 110.

In the examples above in which the server 102 represents a web server which provides a web page and/or associated web-based application to the client 104, it may occur as referenced above that the UI 112 represents an appropriate web browser, such as the example web browsers mentioned above. In other words, and as a matter of common terminology, software code related to both a rendering of a browser and a browser page, as well as associated executable code for performing functions associated with, or provided by, browsers, all may be referred to as being browser-based. In other words, for example, it may be appreciated that either or both of the UI generator 108 and/or the UI 112 itself may be referred to, related to, or enabled by, browser technology.

At the session manager 106 of the server 102, an input handler 114 may be configured to receive various inputs from the user of the client 104, e.g., by way of the UI generator 108 and/or the UI 112. For example, as an initial matter, the input handler 114 may receive an initial request from the user for credential-based access to the server-based resource 105. During later operations, the input handler 114 also may receive various other transmissions from the client 104, some of which are described in detail below.

Further within the session manager 106, an image map generator 116 may be configured to specify the parameters and other features to be associated with an image map 118 that will ultimately be rendered in conjunction with the UI 112, as illustrated in the example of FIG. 1 and described in detail herein below. For example, the image map generator 116 may specify parameters and other characteristics which specify a particular desired implementation of the image map 118.

For example, the image map generator 116 may designate a number and/or type of image map elements which are to be included within the image map for the purpose of receiving input from the user therewith. Further, the image map generator 116 may be configured to generate and associate secure transmission codes with one or more of each of the image map elements included within the image map 118.

For example, in the example of FIG. 1, the image map 118 is illustrated as including image map elements 118A which include, e.g., the numerals 0-9 and symbols “*” and “#.” For each image map element, the image map generator 116 may, as just referenced above, generate a corresponding, secure transmission code. For example, for the numeral 0 to be included as an image map element within the image map 118, the image map generator 116 may generate a random sequence of alpha-numeric characters which are then uniquely associated with a numeral 0 in the context of the image map 118. The process of generating and associating such secure transmission codes (e.g., random numeric strings) may be repeated for each image map element of the image map 118. As described in detail below, the use of such secure transmission codes in a context of the image map 118 provides for transmission of the secure transmission codes between the client 104 and server 102, rather than the transmission of the credentials themselves (i.e., as entered by the user of the client 104 using the UI 112).

In the example of FIG. 1, the session manager 106 may include a credential protection module 120 which may be configured to implement and utilize the just-referenced features of the system 100, i.e., the substitution of the appropriate secure transmission codes from the client 104 to the server 102 in place of the actual credentials as entered by the user using the image map 118. Specifically, as shown, the credential protection module 120 may include a code generator 122 which may receive the image map parameters from the image map generator 116, and thereafter may generate appropriate executable code to enable the UI generator 108 to render and otherwise utilize the image map 118, as described in detail below.

For example, continuing the examples above in which the UI generator 108 and/or the UI 112 represent otherwise conventional browser technology, it may occur that the code generator 102 may be configured to generate hyper-text markup language (HTML) code which may be executable by the appropriate browser functionality (e.g., the UI generator 108), to thereby render the image map 118. Similarly, a code generator 122 may be configured to generate executable code to be included or associated with such HTML code, and which may be instrumental in implementing the use and transmission of the secure transmission codes in place of the transmission of the actual user credential(s) presented by the user using the image map 118.

Specifically, as described in detail below with respect to the UI generator 108, the code generator 122 may include such executable code (e.g., in the form of java script or other appropriate browser-based executable code), so as to enable the UI generator 108 to translate credentials entered by the user using the image map 118 into a corresponding sequence of the relevant secure transmission codes. Consequently, subsequent to such transmission of a sequence of secure transmission codes representing the credentials of the user as entered by the user using the image map 118, a mapping module 124 of the credential protection module 120 may receive the transmitted sequence of secure transmission codes, and may perform a mapping thereof to corresponding image map elements of the image map 118 as originally determined by the image map generator 116, to thereby recover the originally-entered credentials provided by the user using the image map 118 at the UI 112.

At this time, an authentication system 126 may proceed to execute various authentication schemes using the thus-obtained credentials. For example, the authentication system 126 may attempt to relate the received credentials to securely-stored credentials previously associated with the user of the client 104, in order to determine whether to proceed with authentication of the user. If authentication proceeds, then the user may be granted access to the server-based resource 105. On the other hand, if authentication fails (e.g., in the case that the recovered credentials do not match existing credentials stored with respect to the user), then the authentication system 126 may provide information to the user by way of the UI generator 108 and the UI 112, so as to thereby inform the user that authentication has failed. These and other examples of features and functions of the authentication system 126, by themselves, are generally conventional and would be understood to one of skill in the art, and therefore are not described herein in further detail, except as may be necessary or helpful in understanding operations of the system 100 of FIG. 1.

On the client side, during operation, the UI generator 108 may receive the code generated and transmitted by the code generator 122. More generally, an input handler 128 may be understood to represent any one or more input handlers designed to receive input either from the server 102 and/or from the user of the client 104 (e.g., by way of the UI 112).

An image map rendering module 130 may be configured to receive the generated code by way of the input handler 128, and to proceed with rendering the image map 118 based thereon. Somewhat similarly, the generated code received from the code generator 122 at the UI generator 108 may be implemented as a translator 132 which may be configured to execute the below-described translation of credentials received by way of the image map elements 118A and the input handler 128 into a corresponding sequence of the relevant secure transmission codes. A transmitter 134 may thus proceed with transmission of the sequence of secure transmission codes representing the user credentials as entered by the user using the image map elements 118A to the server 102.

It may be appreciated that the system 100 of FIG. 1 provides a number of features and advantages relative to conventional credential-based access schemes. For example, from the user perspective, it is straightforward for the user to request access to the server-based resource 105, receive the image map 118 as rendered by the UI 112, and proceed with entry of relevant credentials, (e.g., a confidential user PIN). For example, the user may use a mouse or other human input device to select, (e.g., click on) a 4 digit PIN simply by selecting the corresponding 4 digits from within the image map elements 118A. In other examples, as referenced above, the UI 112 may be rendered on the client display 110 which may represent a touch screen, in which case the user may select a desired sequence of 4 digits of the user's PIN simply by touching corresponding image map elements 118A using the touch screen of the client display 110. In other words, the user of the system 100 is not required to have any special knowledge or ability beyond what is already required by conventional credential-based access schemes for remembering, tracking, and entering PINS, passwords, or other credentials.

As referenced above, key logging software represented in the example of FIG. 1 by key logger 136 exists which may be used to log keystrokes entered by the user, e.g., during conventional credential-based access techniques. More specifically, as is well known, the key logger 136 may be installed using an operating system 104A of the client 104, and may utilize certain device specific information associated with the operating system 104A in order to track keystrokes of the user. For example, the operating system 104A may be associated with a particular driver or other interface software for providing communications between keyboard or other input device for communication of entered information between the keyboard (or other input device), a particular software application, and/or the client display 110.

In contrast, the image map 118 may be rendered, e.g., in the manner described above, in a manner which is independent of a particular device, platform, or operating system of the client 104. As a result, the key logger 136 may be partially or completely ineffectual in attempting to intercept or detect any selection or entry of a user's credentials by way of the image map elements 118A of the image map 118.

Similarly, as also referenced above, network sniffing software represented by a sniffer 138 in the example of FIG. 1 is known to be used by unauthorized users in an attempt to intercept communications of credentials between the client 104 and the server 102. In the system 100 of FIG. 1, however, it may be appreciated that the sniffer 138, at best, may intercept the sequence of secure transmission codes representing the user credentials as transmitted from a client 104 to the server 102. To the extent that the sniffer 138 has no access to the mapping or other correspondence of the secure transmission codes to corresponding image map elements 118A, such interception of the secure transmission codes by the sniffer 138 would be ineffective in enabling an operator of the sniffer 138 to obtain unauthorized access to the server-based resource 105.

It will be appreciated that many different implementations of the system 100 of FIG. 1 may be utilized. For example, in the example of FIG. 1, the server 102 is illustrated as including at least one processor 102A, as well as computer readable storage medium 102B. Thus, the system 100 may be implemented in whole or in part through the execution of instructions stored on the computer readable storage medium 102B using the at least one processor 102A. For example, such instructions may be executed by the at least one processor 102A to implement the session manager 106, and/or the server-based resource 105 itself

In the example of FIG. 1, the system 100 is illustrated as including a number of separate, discrete components performing the corresponding functions described above. Of course, it may be appreciated that in other embodiments, two or more such components may be implemented together as a single component, or, conversely, a single component illustrated in FIG. 1 may be implemented using two or more separate components. For example, the server 102 may represent one or more server computers each of which may have one or more of the at least one processor 102A, corresponding implementations of the computer readable storage medium 102B (e.g., any appropriate computer memory).

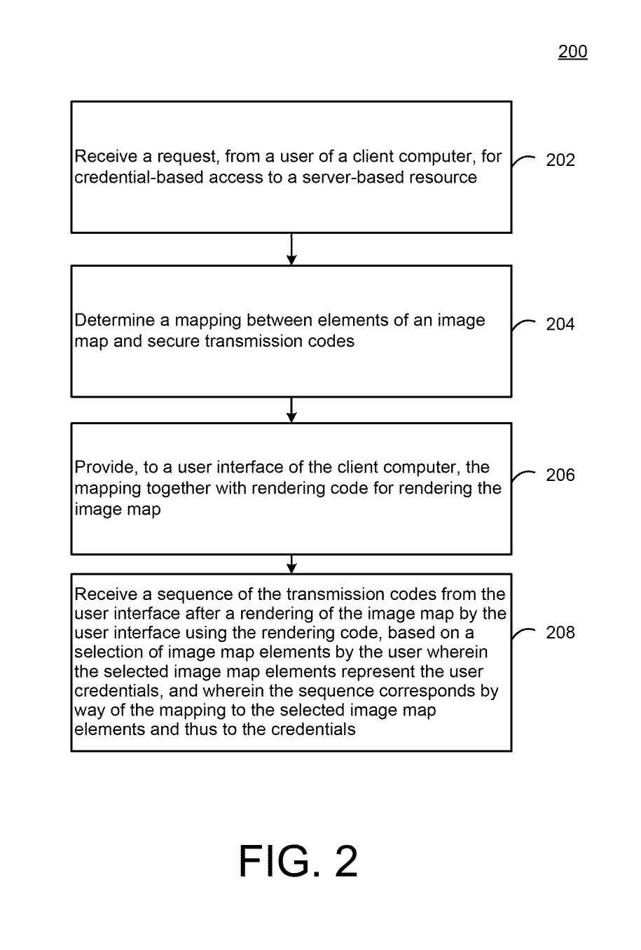

FIG. 2 is a flowchart 200 illustrating example operations of the system 100 of FIG. 1. In the example of FIG. 2, operations 202-208 are illustrated as a sequence of separate, discrete operations. However, it may be appreciated that such illustration is merely for the sake of example, and that many additional or alternative embodiments are possible. For example, two or more of the operations may be performed partially or completely in an overlapping or parallel manner. In other examples, the operations may be performed in a different order than that shown and/or may include additional or alternative operations not specifically illustrated in the example of FIG. 2, and/or may omit one or more of the illustrated operations of the example of FIG. 2.

In the example of FIG. 2, a request may be received from a user of a client computer for credential-based access to a server-based resource (202). For example, with respect to FIG. 1, the input handler 114 may receive a request from a user of the client 104, using the UI 112, for the server-based resource 105.

A mapping between elements of an image map and secure transmission codes may be determined (204). For example, the image map generator 116 of FIG. 1 may initially determine elements of the image map 118 to include therein. For example, the image map generator 116 may simply generate the type of numeric keypad represented by the image map of 118. In other examples, the image map generator 116 may include a conventional full keyboard for rendering as the image map 118. In additional or alternative examples, the image map generator 116 may generate the image map 118 as including a full set of keys of a conventional keyboard, but arranged in a different format than a standard keyboard format (e.g., the QWERTY format). In still other examples, it may occur that the credentials which may be utilized by the user for accessing the server-based resource 105 have been limited to some subset of alpha-numeric characters and/or may use non-conventional characters. In such cases, the image generator 116 may be generated in virtually any form which is configured to include whatever characters or elements may be necessary for receipt of credentials from the user.

Whatever form or format the image map may take, the image map generator 116 may be configured to generate a secure transmission code for each image map element, and further configured to store a relationship or other mapping between each such secure transmission code and its corresponding image map element. As described herein, such secure transmission code may include anything from a single digit or character which is different than its corresponding image map element, to a relatively lengthy character string which is mapped to a corresponding image map element.

More generally, it may be appreciated that the image map generator 116 may construct secure transmission codes and mappings therebetween with the image map elements in any manner which is thought to confuse or otherwise make it more difficult for a potential unauthorized user to relate the secure transmission codes to their corresponding image map elements, or to otherwise recover image map elements from the secure transmission codes. Although not specifically illustrated in the example of FIG. 1, it may be appreciated that the secure transmission codes and mappings there between and the corresponding image map elements may be stored using an appropriate memory (e.g., an implementation of the computer readable storage medium 102B), and that the secure transmission codes and associated mapping may therefore be accessible by other components of the server (e.g., the mapping module 124, as described herein).

The mapping may be provided together with rendering code for rendering the image map to a user interface of the client computer (206). For example, the code generator 122 may generate such rendering code, e.g., HTML code in the case where the user interface includes a web browser. As referenced, the code generator 122 may further include java script or other executable code which will enable the user interface to render the image map 118, to receive selections of individual image map elements 118A in a sequence designated by the user and corresponding to the credentials of the user, and to map the selected sequence of image map elements into a corresponding sequence of the secure transmission codes, using the mapping as previously determined by the image map generator 116 and as included with the rendering code provided to the user interface generator 108.

Thus, the UI generator 108 may be configured to receive the rendering code and all related information at the input handler 128, whereby the image map rendering module 130 may be generated and configured to render the image map 118 including the image map elements 118A. Upon receipt of a selected sequence of the image map elements 118A by the user, the translator 132 may translate the sequence of image map elements into a corresponding sequence of secure transmission codes, as just referenced. Thereafter, the transmitter 134 may be configured to transmit the sequence of secure transmission codes to the mapping module 124 of the credential protection module 120.

Thus, in this manner, a sequence of the secure transmission codes may be received from the user interface after the rendering of the image map by the user interface using the rendering code, and based on selections of image map elements by the user, wherein the selected image map elements represent the user credentials, and wherein the sequence of transmission codes correspond by way of the mapping to the selected image map elements and thus to the credentials (208). For example, as just referenced, the mapping module 124 may be configured to receive the sequence of secure transmission codes as received from the transmitter 134. Consequently, the mapping module 124 may be configured to recover the credentials by relating the received sequence of secure transmission codes back to the user credentials, for providing thereof to the authentication system 126, and subsequent authentication of the user for use of the server-based resource 105 based thereon.

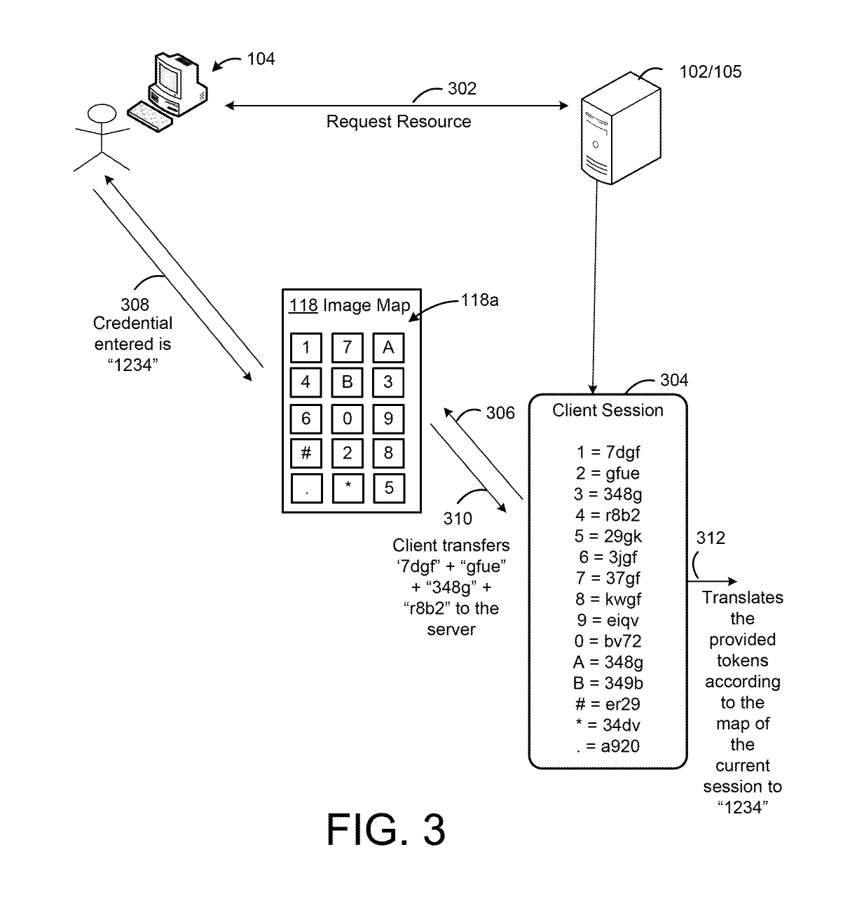

FIG. 3 is a block diagram illustrating example information flows in the context of the system 100 of FIG. 1, in accordance with operations of the flowchart 200 of FIG. 2. In the example of FIG. 3, as shown, a request for resource (e.g., the server-based resource 105) may be transmitted from a client computer and associated user 104 to a server 102 during an operation 302. After the operation 302 in which the resource is requested, operation 304 may be executed in which the client session is established and secure transmission codes are generated and associated with image map elements of the image map 118 to be rendered.

As shown, the image map elements may include alpha-numeric characters which are associated with random character strings, where it may be appreciated that the random character strings may be of virtually any desired link and/or content, while the included image map elements, as referenced above, may be selected so as to ensure that all necessary elements are present for receipt of credentials from the client/user 104. In some embodiments, the image map elements themselves and/or the secure transmission codes associated therewith may be changed, so as to thereby increase a level of security associated with implementations of the techniques described herein. For example, the image map elements 118A and/or secure transmission codes may be changed for each authentication request from the client 104, even if the actual credentials of the user remain constant. Such changes to the image map elements (e.g., changes to which image map elements are included and/or changes to an arrangement of the image map elements relevant to one another) may be executed in conjunction with each new session, or may be changed within a context of a given session, e.g., may be changed periodically or in response to a threat or perceived threat of attempted access by an unauthorized user.

At an operation 306, the image map 118 may be provided to the user at the client 104. For example, as referenced above, rendering code and associated executable code for rendering the image map 118 and receiving selections of the sequence of elements therefrom may be provided to the client 104. Consequently, as described, the user of the client 104 may use appropriate input techniques to select desired ones of the image map elements, e.g., may use a mouse to click on desired elements, or may use a stylist or finger to make physical contact with the touch screen used to render the image map 118.

As described above, such techniques may make it difficult or impossible for potential unauthorized users seeking to deploy a keyboard logger and/or sniffer to detect or intercept transmitted credentials from a user. Nonetheless, in some contexts, it may occur that potential unauthorized users may attempt to use optical character recognition (OCR) in order to detect selections of the user of particular image map elements.

In order to guard against such possibilities, the image map 118 may be constructed and generated for rendering in a manner which makes computer detection of optical characters difficult or impossible. Such techniques for rendering character strings in a manner that is not readable by optical character recognition techniques of computers are, by themselves, well known. For example, the term captcha refers to the use of such computer-unrecognizable characters used, e.g., to validate a presence of a human user attempting to log on to a system. These and similar techniques may be used to render the image map elements 118A of the image map 118 in an individualized, non-standard manner which is easily readable by a human user (i.e., is human-only readable), but which is difficult or impossible for a computer to recognize.

Further, as referenced above, additional or alternative steps may be taken to increase the difficulty of a task of an unauthorized user in detecting selection of image map elements by the user. For example, the image map 118 may be rendered with the image map elements arranged in a non-standard format. For example, letters and/or numbers may be presented in a random fashion (such as in FIG. 3, where numbers in the image map 118 are arranged in a non standard format and where letters are interspersed with the numbers), and/or keyboard keys may be presented in a scrambled or otherwise non-standard format. It may be appreciated that any such techniques may be executed independently of, or in conjunction with, the above-referenced techniques of changing the selected secure transmission codes associated with the image map elements (e.g., providing a different mapping between existing secure transmission codes and image map elements, or utilizing entirely new secure transmission codes).

In the example of FIG. 3, it is illustrated for the sake of example that the user of the client 104 enters credentials including the numeric string 1-2-3-4. In an operation 308, such credentials are entered into the image map 118, whereupon the client 104 (e.g., the translator 134 of the UI generator 108) may translate the received sequence into a corresponding sequence of the relevant secure transmission codes. In the example, as shown, the secure transmission codes are represented as the sequence 7dgf+gfue+348g+r8b2, which is transmitted to the server 102 by the transmitter 134, as part of operation 310.

Finally in FIG. 3, at the server 102, the received sequence of secure transmission codes may be mapped to individual image map elements, to thereby recover the entered sequences of the image map elements and thus the credentials of the user. At such time, the recovered credentials may be used by the authentication system 126 of the server 102 to proceed with an otherwise-standard authentication of the user therewith.

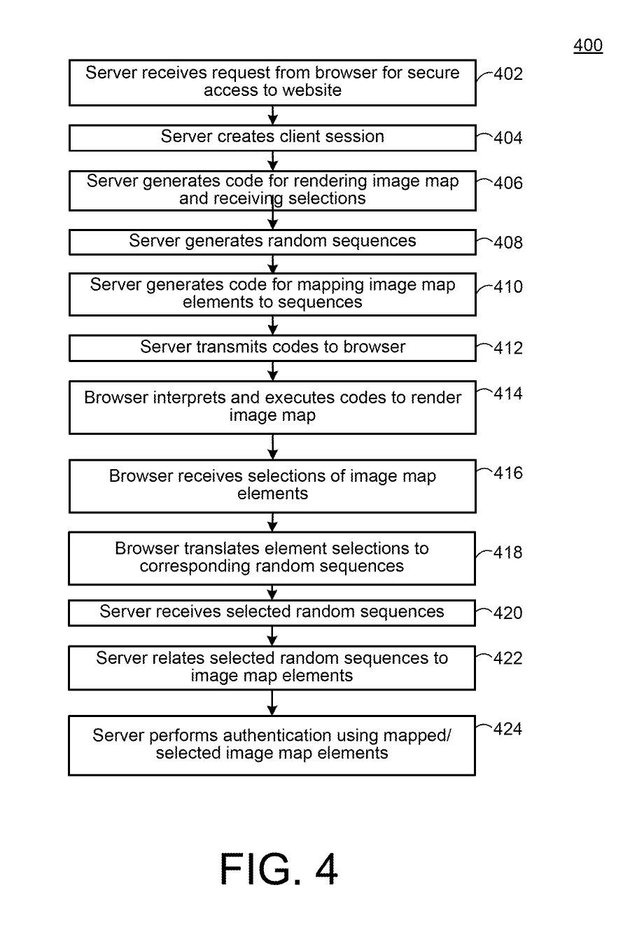

FIG. 4 is a flowchart 400 illustrating more detailed example operations of the system 100 of FIG. 1. More specifically, FIG. 4 provides example operations in which the server 102 includes a web server configured to provide a secure website to a user, such as the examples provided above of financial or retailer websites.

Thus, in the example of FIG. 4, the server 102 (e.g., the input handler 114) may receive a request for secure access to the provided website, by way of browser used by the user to receive and render the website (402). For example, as referenced, the user may enter a uniform resource locator (URL) or otherwise visit a homepage or front page of the financial or retail website in question, and may thereafter select a link for logging into an individual user account associated with the user and maintained by the server 102 for use as the server-based resource 105.

In response to the request for access, the server 102 (e.g., the session manager 106), may generate a user session to be specific to the client (404). The image map generator 116 may thereafter implement one or more algorithms to generate a particular image map, including making decisions about which image map elements to include, how to arrange the image map elements relevant to one another, and how to render the image map elements and receive selections thereof from the user (406).

In conjunction with the configuration of the image map, the server 102, (e.g., the image map generator 116), may generate random sequences of alpha-numeric characters to serve as the secure transmission codes (408). Also at the server 102, the code generator 122 may generate the associated HTML and java script code for mapping the just-as-created image map elements to corresponding ones of the also just-as-generated random sequences (410). Then, the server 102 may transmit all generated code related to the image map to the browser requesting access (412). The browser may thus receive, interpret, and execute the codes to render the image map for the user (414). Consequently, the browser may receive individual selections of the image map elements from the user (416), and thereafter translate the sequence of element selections and to corresponding sequence of the random sequences (418), e.g., through implementation of the translator 132.

The server 102 may thus receive the selected sequence of random sequences from the browser (420), e.g., from the transmitter 134, and may proceed to relate the received sequence of random sequences to corresponding image map elements (422), to thereby recover the actual user credentials. Finally, the server 102, e.g., using the authentication system 126, may proceed to perform authentication using the selected image map elements corresponding to the recovered credentials (424), to thereby provide secured access to the server-based resource 105.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A system including instructions recorded on a computer-readable medium and executable by at least one processor, the system comprising:
an input handler configured to cause the at least one processor to receive a request, from a user of a client computer, for credential-based access to a server-based resource;
an image map generator configured to cause the at least one processor to determine a mapping between elements of an image map and secure transmission codes;
a code generator configured to cause the at least one processor to provide, to a user interface of the client computer, the mapping together with rendering code for rendering the image map;
a mapping module configured to cause the at least one processor to receive a sequence of the transmission codes from the user interface after a rendering of the image map by the user interface using the rendering code, based on a selection of image map elements by the user, wherein the selected image map elements represent the user credentials, and wherein the sequence corresponds by way of the mapping to the selected image map elements and thus to the credentials.

2. The system of claim 1 comprising:
an authentication system configured to authenticate the user and thereby authorize access to the server-based resource, based on the credentials.

3. The system of claim 1 comprising a session manager, wherein the session manager is configured to cause the at least one processor to establish a session for the access to the server-based resource.

4. The system of claim 3 wherein the image map and mapping between the image map elements and the secure transmission codes may be persisted outside of the session.

5. The system of claim 3 wherein the image map generator may be configured to change the image map elements, the secure transmission codes, and/or the mapping therebetween, within the session.

6. The system of claim 1 is wherein the secure transmission codes include corresponding random alpha-numeric strings.

7. The system of claim 1 wherein the image map generator is configured to generate the rendering code including Hyper Text Mark-Up Language (HMTL) code.

8. The system of claim 1 wherein the image map elements include alpha numeric elements selected as being sufficient to enable entry of the credentials therewith.

9. The system of claim 1 wherein the image map includes an image of a keyboard.

10. The system of claim 1 wherein the image map elements include at least a subset of a randomized keyboard.

11. The system of claim 1 wherein the image map generator is configured to generate the image map elements including human-only readable elements.

12. The system of claim 1 wherein the image map is generated independently of the client computer.

13. A computer program product, the computer program product being tangibly embodied on a computer-readable storage medium and comprising instructions that, when executed by a data processing apparatus, are configured to cause the data processing apparatus to:
receive a request, from a user of a client computer, for credential-based access to a server-based resource;
determine a mapping between elements of an image map and secure transmission codes;
provide, to a user interface of the client computer, the mapping together with rendering code for rendering the image map; and
receive a sequence of the transmission codes from the user interface after a rendering of the image map by the user interface using the rendering code, based on a selection of image map elements by the user, wherein the selected image map elements represent the user credentials, and wherein the sequence corresponds by way of the mapping to the selected image map elements and thus to the credentials.

14. The computer program product of claim 13 wherein the executable code, when executed, is configured to cause the data processing apparatus to authenticate the user and thereby authorize access to the server-based resource, based on the credentials.

15. The computer program product of claim 13 wherein the executable code, when executed, is configured to cause the data processing apparatus to establish a session for the client computer for access to the server-based resource therein.

16. A computer-implemented method comprising:
receiving a request, from a user of a client computer, for credential-based access to a server-based resource;
determining a mapping between elements of an image map and secure transmission codes;
providing, to a user interface of the client computer, the mapping together with rendering code for rendering the image map; and
receiving a sequence of the transmission codes from the user interface after a rendering of the image map by the user interface using the rendering code, based on a selection of image map elements by the user, wherein the selected image map elements represent the user credentials, and wherein the sequence corresponds by way of the mapping to the selected image map elements and thus to the credentials.

17. The method of claim 16 comprising:
authenticating the user and thereby authorizing the user for access to the server-based resource, based on the credentials.

18. The method of claim 16 comprising establishing a session in which the access to the server-based resource occurs.

19. The method of claim 16 wherein the image map elements include alpha numeric elements selected as being sufficient to enable entry of the credentials therewith.

20. The method of claim 16 wherein the image map includes at least a subset of a randomized keyboard.
